(19) United States
(12) Patent Application Publication
(10) Pub. No.: US 2015/0324840 A1
(43) Pub. Date: Nov. 12, 2015

(54) SYSTEMS AND METHODS FOR RENDERING AUTOSTEREOSCOPIC THREE-DIMENSIONAL ONLINE ADVERTISEMENTS

(71) Applicant: TURN INC., Redwood City, CA (US)

(72) Inventor: Harshini RAMNATH KRISHNAN, Sunnyvale, CA (US)

(21) Appl. No.: 14/272,393

(22) Filed: May 7, 2014

(51) Int. Cl. G06Q 30/02; G06T 15/00

(52) U.S. Cl. CPC G06Q 30/0251; G06T 15/005

(57) ABSTRACT

Systems and methods for rendering three-dimensional (3D) online advertisements on electronic devices are described. An advertiser provides a two-dimensional (2D) version of an advertisement, and the 2D version is converted to a 3D format appropriate for rendering for display on a particular electronic device. The conversion from 2D to 3D can be done online or offline, and the converted 3D versions are tagged by format for storage in a database for subsequent retrieval. The advertiser further specifies targeting options for the 3D ad, and the 3D version of the ad is rendered only for ad inventory meeting the targeting options, where the targeting options can specify conditions under which a 2D version of the ad is rendered and conditions under which a 3D version of the ad is rendered.

### BACKGROUND

Two-dimensional advertisements are commonly seen online when using a browser to visit various websites using an electronic device. An advertisement shown on a webpage can be purchased by an advertiser in different ways. Real-time bidding is one method used to buy and sell ad impression inventory in the time it takes the webpage to load. In a real-time bidding auction, when a user visits a website, a bid request is triggered, and the request can include demographic information about the user, browsing history of the user, the location of the user, and the webpage being loaded. Advertisers bid on individual ad impressions as they are served, and the highest bidder's ad is rendered on the webpage. Conversion tracking can subsequently be performed to determine the advertiser's return on investment.

Direct buy and shared buy are other methods used to buy and sell ad impression inventory. With direct buy, an agreement is made with a publisher to buy impressions in bulk so that ads are seen in a specific context, such as on a particular website. With shared buy, an agreement is made with multiple inventory sources for impressions.

### BRIEF DESCRIPTION OF THE DRAWINGS

Examples of systems and methods for rendering autostereoscopic three-dimensional online advertisements are illustrated in the figures. One or more embodiments of the present disclosure are illustrated by way of example and not limitation in the figures of the accompanying drawings.

FIG. 1 depicts an example of a networked-based environment in which a host server can render three-dimensional online advertisements.

FIG. 2 depicts an example block diagram of a host server that renders autostereoscopic three-dimensional online advertisements.

FIGS. 3A-3F is a flow diagram illustrating an example process performed by the host server for rendering an autostereoscopic three-dimensional online advertisement.

FIG. 4 is a block diagram showing an example of the architecture for a processing system that can be used to implement the techniques for rendering autostereoscopic three-dimensional online advertisements according to an embodiment of the present disclosure.

### DETAILED DESCRIPTION

Systems and methods for rendering three-dimensional (3D) online advertisements on electronic devices are described. An advertiser provides a two-dimensional (2D) version of an advertisement, and the 2D version is converted to a format appropriate for rendering for display on a particular electronic device. The conversion from 2D to 3D can be done online or offline, and the converted 3D versions are tagged by format for storage in a database for subsequent retrieval. The advertiser further specifies targeting options for the 3D ad, and the 3D version of the ad is rendered only for ad inventory meeting the targeting options, where the targeting options can specify conditions under which a 2D version of the ad is rendered and conditions under which a 3D version of the ad is rendered.

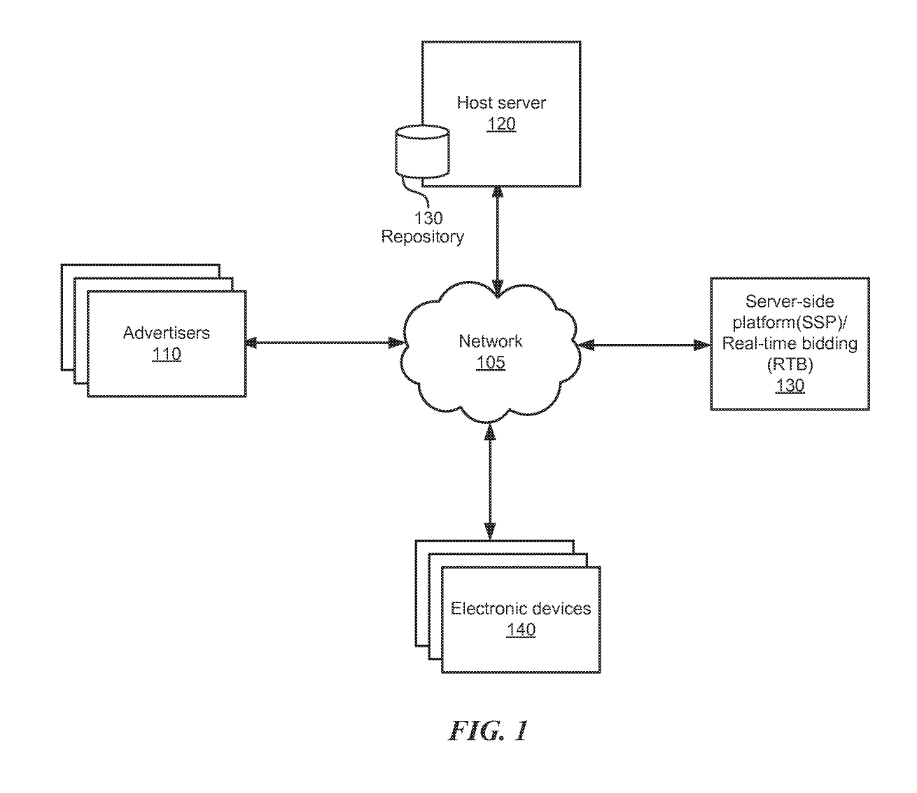

FIG. 1 depicts an example of a networked-based environment where a host server 120 supports receiving two-dimensional (2D) images or videos and rendering an autostereoscopic three-dimensional (3D) version of the two-dimensional image or video as an online advertisement on an electronic device 140.

The host server 120 can receive, via the network 105, 2D and/or 3D images or videos from advertisers or media buyers 110 for rendering as an online advertisement on an electronic device 140. In some instances, the host server 120 converts the received 2D image or video to an appropriately formatted autostereoscopic 3D image or video suitable for display on a particular electronic device. In some instances, the host server 120 can transmit the received 2D image or video to an external server or system (not shown) for conversion to an appropriately formatted 3D image or video. In some instances, the host server 120 can receive an autostereoscopic 3D image or video for display that is either ready for rendering as an online advertisement, or requires further formatting by the host server 120 prior to rendering for display on a particular electronic device.

The advertisers 110 also provide audience targeting information for the impression along with the image or video. Audience targeting information can include user demographics, geographic location of the user, and type of electronic device. Examples of electronic devices 140 that can display the autostereoscopic 3D online advertisements include a computer, mobile phone, smartphone, and tablet.

The host server 120 is configured to interact with a server-side platform (SSP) or a real-time bidding (RTB) auction 130 to bid on impressions that meet the specified audience targeting information, or to buy inventory in a direct or shared buy environment that meets the targeted audience characteristics. Additionally, the host server 120 can tag and store received and converted 2D and 3D images and videos in a repository 130. The repository 130 can be a single database or made up of several separate databases. Further, the repository can be external or internal to the host server 120.

The network 105 can be any collection of distinct networks operating wholly or partially in conjunction to provide connectivity to the electronic devices 140 and the host server 120 and may appear as one or more networks to the serviced system and devices. In some embodiments, communications to and from the client devices 140 can be achieved by an open network, such as the Internet, or a private network, such as an intranet and/or the extranet.

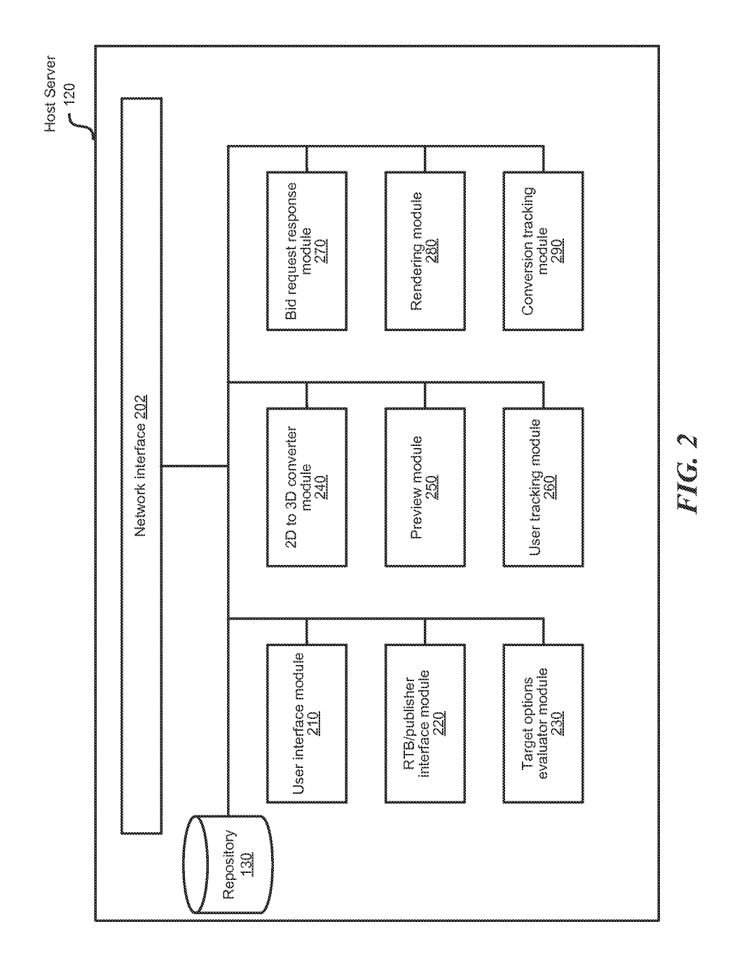

FIG. 2 depicts a block diagram illustrating an example of components in the host server 120 that support rendering an autostereoscopic 3D online advertisement to an electronic device. The host server 120 can include, for example, a network interface 202, a user interface module 210, an RTB/publisher interface module 220, a target options evaluator module 230, a 2D to 3D converter module 240, a preview module 250, a user tracking module 260, a bid request response module 270, a rendering module 280, a conversion tracking module 290, and/or a repository 130. Additional or fewer components/modules can be included in the host server 120 and each illustrated component.

The host server 120 and all of the elements included within the host server 120 can be implemented by using programmable circuitry programmed by software and/or firmware, or by using special-purpose hardwired circuitry, or by using a combination of such embodiments. Additional or fewer elements can be included in the host server 120 and each illustrated component. As used herein, a “module” of the host server 120 includes a general purpose, dedicated or shared processor and, typically, firmware or software modules that are executed by the host server 120. Some parts of the functionalities may be integrated in hardware as well. Depending upon implementation-specific or other considerations, the module can be centralized or its functionality distributed. The module can include general or special purpose hardware, firmware, or software embodied in a computer-readable (storage) medium for execution by the host server 120.

The network interface 202 can be a networking module that enables the host server 120 to mediate data in a network with an entity that is external to the host server 120, through any known and/or convenient communications protocol supported by the host and the external entity.

In some embodiments, the host server 120 includes the user interface module 210 which provides advertisement targeting options to an advertiser. The advertiser can identify specific targeting options for each online advertisement campaign. If an ad impression or inventory meets the targeting options specified by the advertiser, the ad impression will be purchase on behalf of the advertiser, and the advertiser's ad will be rendered for display to a user on a particular electronic device. Targeting options can include behavioral targeting, contextual targeting, retargeting, geo targeting, technographic targeting, gender targeting, deal targeting, and site list targeting. Behavioral targeting options allow an advertiser to target users who, for example, visit a particular website or webpage, spend a certain amount of time viewing each website or webpage, perform searches with particular keywords, and/or click on particular links. Contextual targeting options permit an advertiser to identify specific webpage content for placing the online ad. Retargeting options allow an advertiser to specify that ads are to be served only to users who have previously visited a particular website, such as the advertiser's website. Geo targeting options permit an advertiser to specify users situated in specific geographic regions for receiving an ad. Technographic targeting options permit an advertiser to specify users having specific computer equipment, such as browser type and version, language setting, operating system, connection speed, domain, top level domain, and/or internet protocol (IP) address. Gender targeting options allow an advertiser to specify if an ad should be targeted to men or women. Deal targeting options allow an advertiser to identify as targets, users who have responded to a particular online deal. Site list targeting options allow an advertiser to identify specific websites or types of websites on which the advertiser's ads should or should not be placed.

Targeting options can also be specific to conditions under which a 2D ad or 3D ad should be rendered. For example, the advertiser can specify whether the ad to be rendered is 2D or 3D, the total number of 2D versions of the ad and 3D versions of the ad that should be rendered, and whether there is an advertising budget that restricts the total number of 3D ads to be rendered.

Additionally, conditions under which the 3D version of the ad should be rendered can be specified. In one example, an advertiser can specify that a lower cost 2D ad should be rendered to users who are in the age range 30 and up because users in this age group are not sufficiently engaged by a 3D ad, while users in the age group 15-30 should be served the 3D version of the ad. In another example, an advertiser can specify that users in the United States should be served the 3D version of the ad, while users outside the United States should not be served the 3D version of the ad because the product and ad campaign are targeted toward United States customers. In yet another example, an advertiser can specify that only a single impression of an ad, whether 2D or 3D, should be served to any particular user. More generally, the advertiser can specify an impression cap which is the maximum number of times that an ad can be served to the same user and/or a frequency cap which is the maximum frequency with which an ad can be served to the same user. Impression caps and frequency caps prevent users from becoming accustomed to seeing the same ad and ignoring the ad altogether, and guarantees that a minimum total number of users re reached for a given ad campaign budget.

In some instances, the host server 120 includes an RTB/publisher interface module 220. In the case of an RTB environment, the RTB/publisher interface module 220 receives from the RTB auction a request for bids for an impression for a specific user at a specific website. The request for bids can include other relevant information, such as, demographic and behavioral information on the user and the type of electronic device on which the ad will be rendered. In the case of a direct buy or shared buy, the RTB/publisher interface module 220 receives from publishers information on the context where online advertisements will be placed and information regarding the type of electronic device that will be displaying the online advertisement.

Based on the information received by the RTB/publisher interface module 220 and the targeting options selected by the advertiser and received by the user interface module 210, the target options evaluator module 230 determines whether an impression for bid in the case of an RTB environment or inventory in the case of a direct or shared buy meets the selected targeting options. Each targeting option specified by the advertiser is compared to the characteristics of the impression for bid or inventory, and only the impressions or inventory matching the specified targeting options are chosen as candidates for rendering the advertiser's ad.

In some embodiments, the host server 120 includes the bid request response module 270 which responds to RTB bid requests. Thus, if the target options evaluator module 230 determines that a bid should be made on an impression, the bid request response module 270 determines an appropriate bid and submits it in response to the bid request. The bid request response module 270 is notified by the RTB auction whether or not the bid that was submitted is the winner of the auction. If the bid is the winner, the rendering module 280, described below, renders the appropriately formatted version of the ad as an online ad to the user of the electronic device for which the bid was made.

In some embodiments, the host server 120 includes the 2D to 3D converter module 240 which takes a 2D image or video and converts it to a 3D image or video. In some embodiments, the 3D image or video is autostereoscopic so the viewer of the 3D image/video does not need special glasses to experience the 3D effect. The converted 3D image or video should have an appropriate format for a specific targeted electronic device for which the 3D version will be rendered. For example, the format rendered for a mobile device may be different from the format rendered for a computer or tablet. Moreover, the format of the 3D image/video that is rendered on a particular type of mobile device, such as a smartphone running an Android operating system, may be different from the format rendered on an iPhone. Thus, the 2D to 3D converter module 240 should take into account the information received by the RTB/publisher interface module 220 about the type of electronic device on which a particular online ad will be rendered when performing the conversion. After converting the image/video to 3D, the converted version is tagged with the corresponding format and stored in the repository 130 for subsequent retrieval.

The 2D to 3D converter module 240 can also provide different resolutions of the 3D versions of a particular image/video. For example, different resolutions of the 3D image/video may be more suitable for a particular device type.

In some embodiments, the 2D to 3D converter module 240 performs the conversions online in real time during an RTB bid process. In some embodiments, the 2D to 3D converter module 240 pre-converts the 2D image/video to the appropriate 3D formats for subsequent use. Pre-conversion may enable a faster turn-around time if the conversion algorithm takes a noticeable amount of time to execute, for example, more than a second.

In some cases, the 2D to 3D converter module 240 is internal to the host server 120. In some cases, the host server 120 can send a 2D image or video for conversion to a 3D image or video to a 2D to 3D converter module external to the host server 120 and specify the format for conversion. Then upon receiving the converted image/video, the 2D to 3D converter module 240 tags the image/video with the appropriate format before storing in the repository 130.

The preview module 250 can provide a preview of a converted 3D image or video to the advertiser. Upon viewing the preview, the advertiser can decide whether the converted image/video is acceptable prior to confirming a media buy with the host server 120.

In some embodiments, the host server 120 includes a user tracking module 260 which tracks the users to which ads have been rendered and stores the information in the repository 130. The user tracking module 260 can use this information to determine whether an impression cap and/or a frequency cap specified by the advertiser via the user interface module 210 has been reached. If the number of impressions rendered to a user of a particular ad exceeds the impression cap and/or the frequency with which the particular ad has been rendered to the user has been exceeded, the ad will not be rendered again to the same user. The impression cap and/or frequency cap prevent users from becoming accustomed to seeing the same ad and ignoring the ad, thus wasting an ad campaign budget.

The host server 120 includes a rendering module 280 that renders an online ad for viewing by a targeted user of an electronic device. The rendering module 280 renders the appropriate format of the 2D or 3D image/video upon winning a bid in the RTB environment or when the target options evaluator module 230 identifies that the target options specified by the advertiser have been met for a particular impression identified by a direct or shared buy.

In some embodiments, the host server 120 includes a conversion tracking module 290 which performs tracking of online ads rendered by the rendering module 280 to determine whether a conversion has occurred for a rendered ad. Conversion tracking techniques used by the conversion tracking module 290 are known to those skilled in the art. For example, the conversion tracking module 290 can track certain metrics, such as the number of impressions rendered on a website.

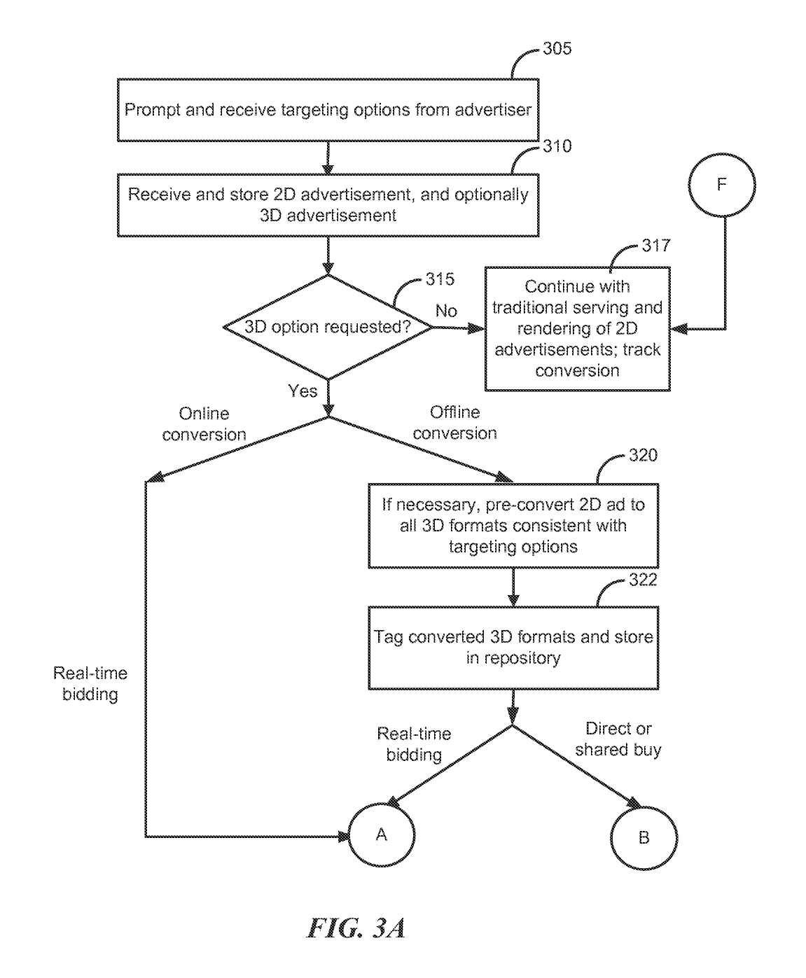

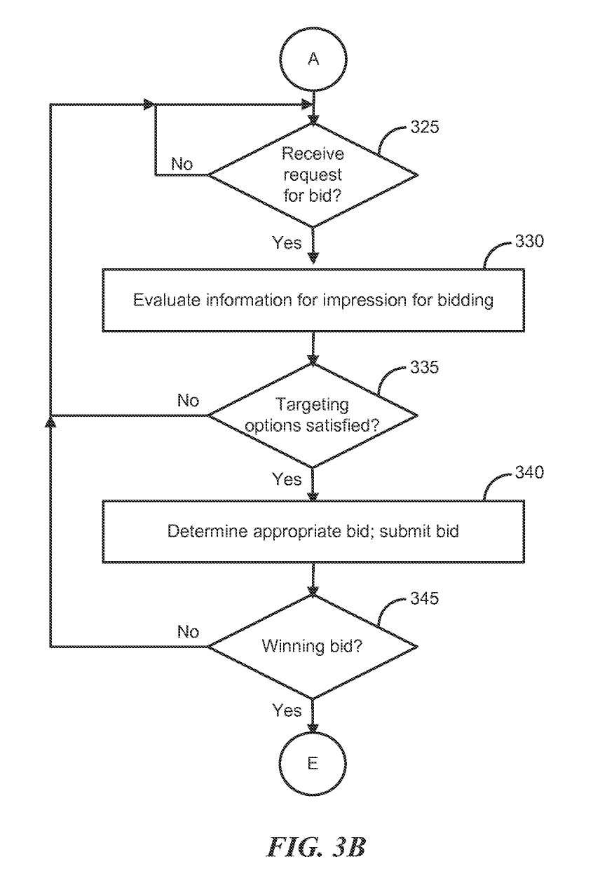

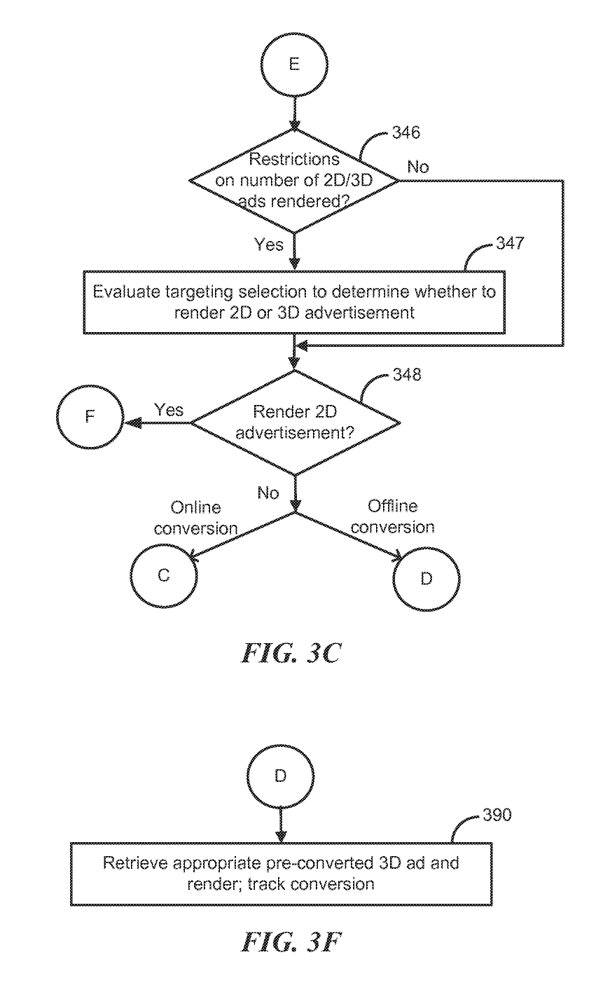

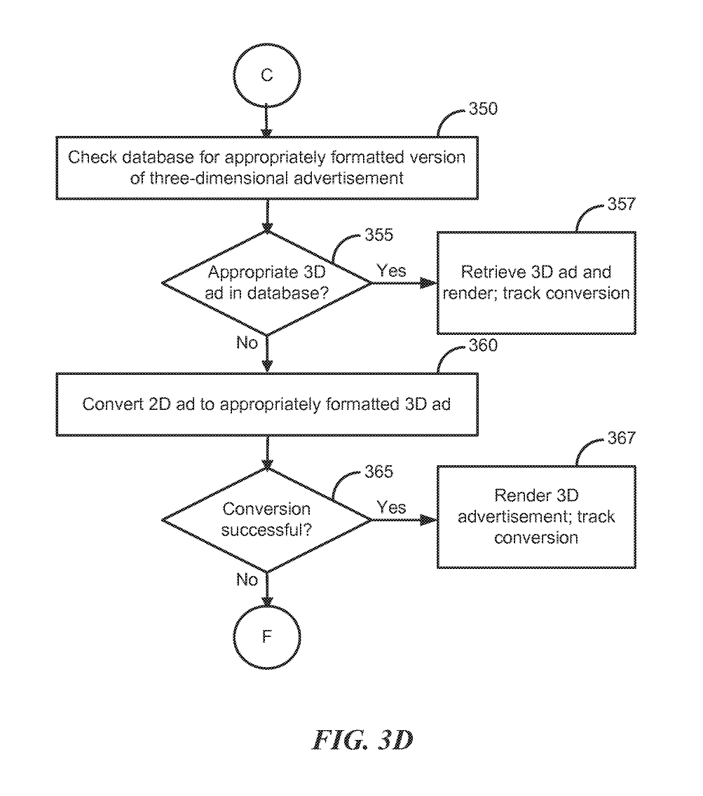

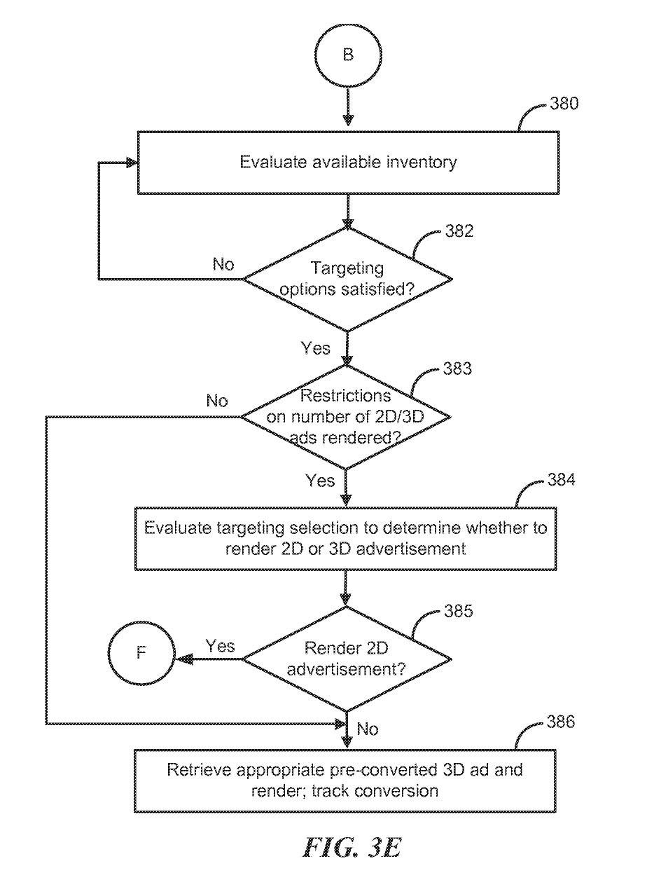

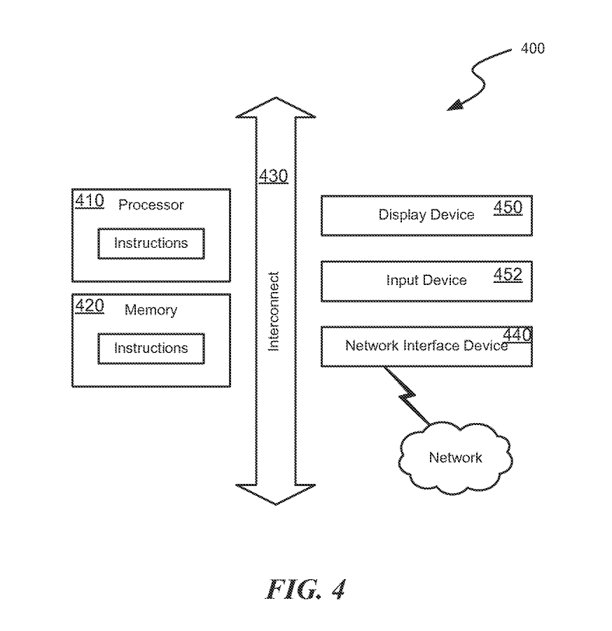

FIGS. 3A-3F is a flow diagram illustrating an example process performed by the host server for rendering a stereoscopic three-dimensional advertisement.

At block 305, the server prompts and receives targeting options from an advertiser that wants to place an online advertisement. Targeting options can include types of electronic devices on which the online advertisements will be displayed; desired channel selection for the ad, such as social media networks, applications, websites, and videos; behavioral targeting selections; contextual targeting selections; retargeting selections; geo targeting selections; technographic targeting selections; gender targeting selections; deal targeting selections; and site list targeting.

Additionally, the server prompts and receives information on whether 2D or 3D ads should be served. For example, an advertiser can specify that that the 3D version of the ad should be rendered only for users in the United States, and the 2D version of the ad should be rendered for all other user locations. The advertiser may select this distinction because a product is targeted toward customers in the United States, and each 3D ad impression that is rendered may be more costly than each 2D ad impression. The advertiser can also choose to select a percentage of impressions or a percentage of an advertising budget to be used for rendering 3D ads, while the rest of the budget is used for rendering 2D ads. The advertiser can also dynamically change the allotment of a budget to be used for rendering 3D ads based upon conversion statistics for 3D ads and 2D ads.

Then at block 310, the server receives a 2D advertisement from the advertiser and stores it in the database. If the advertiser only provides a 2D version of the advertisement, the server can provide conversion services and convert the 2D image/video to a 3D version with the appropriate formatting and resolution for a particular impression to be displayed on a targeted electronic device. Additionally or alternatively, the server can receive one or more formats for a 3D version of the 2D advertisement, or an independent 3D advertisement with no corresponding 2D version that the advertiser wants rendered to users of electronic devices as impressions. When the server receives a 3D version of an online advertisement, the server may still need to re-format the 3D version to an appropriate format for display on a target electronic device.

Next, at decision block 315, the server determines whether the advertiser requested 3D ads to be rendered at block 305. If 3D ads are not requested to be rendered (block 315—No), at block 317, the server continues with traditional serving and rendering of 2D ads, as is currently known in the art. The server can also track conversion of served 2D ads.

If 3D ads are requested to be rendered (block 315—Yes), there are two paths for proceeding. The system can be configured to perform either online or offline conversion of 2D ads to 3D ads. If the system is configured to only perform offline conversions of ads from 2D to 3D, at block 320, the server pre-converts the received 2D ad to all 3D formats consistent with targeting options. For example, if the advertiser requests rendering of 3D ads only for iPhone smartphones, then the server can pre-convert the 2D ad to the appropriate format for rendering on an iPhone. Other 3D formats would be unnecessary in this case.

Then at block 322, the server tags each of the converted 3D formats with information about the electronic device intended to render it and stores the tagged 3D format in the repository. The process continues, as described below, depending on whether the server will be participating in real-time bidding for impressions for the ad or placing the ad based on inventory from a direct or shared buy.

Returning to the point in the process after decision block 315, if the system is configured to perform online conversions of ads from 2D to 3D, the online conversions will only be required for the case of RTB because there is no need for real-time conversions outside the context of RTB. Thus, no pre-conversions of the 2D ads are performed. For direct buy and shared buy inventory, the system can still take the time to pre-convert 2D ads, as needed, as described above.

For RTB for either online or offline conversion, the process continues at decision block 325 where the server determines whether a request for bid has been received from an RTB auction. If no request for bid is received (block 325—No), the process remains at decision block 325.

If a request for bid is received (block 325—Yes), at block 330, the server evaluates the information provided for the impression for bidding. The information can include the type of electronic device that will display the rendered ad, the website, and other information about the user who will see the ad. At decision block 335, the server determines whether the targeting options selected by the advertiser are met by the impression for bid. Note that the targeting options evaluated at decision block 335 do not determine whether a 2D or 3D ad should be rendered. The targeting options only consider whether the impression meets the advertiser's requirements for whether the ad should be placed. If the targeting options are not satisfied (block 335—No), the process returns to decision block 325.

If the targeting options are satisfied (block 335—Yes), at block 340, the server determines an appropriate bid and submits the bid. Next, at decision block 345, the server determines whether the submitted bid is the winner. If the bid is not the winner (block 345—No), the process returns to decision block 325. If the bid is the winner (block 345—Yes), at decision block 346, the server determines whether there are any restrictions on the number of 2D and 3D ads that are to be rendered.

If there are restrictions (block 346—Yes), at block 347, the server evaluates targeting selections provided by the advertiser to determine whether to render the 2D version or the 3D version of the ad. Examples of rules that may be evaluated include whether the total number of 3D ads to be rendered has been met, whether the budget for rendering 3D ads has been reached, and whether any age or geographic limitations have been provided for serving the 3D ad. At decision block 348, the server determines whether the 2D version of the ad should be rendered. If the server determines that the 2D version of the ad should be rendered (block 348—Yes), the process returns to block 317 for traditional serving and rendering of the 2D version of the ad. If the server determines that the 3D version of the ad should be rendered (block 348—No), there are two paths, depending upon whether the system is set up to perform online or offline conversions.

For online conversions, at block 350, the server checks the repository for whether an appropriately formatted 3D version of the ad is available. The repository can be searched based on tags that identify the format of the 3D ad. Then at decision block 355, the server determines whether an appropriately formatted 3D ad is in the database. If the appropriately formatted 3D ad is in the database (block 355—Yes), at block 357 the server retrieves the 3D ad and renders it. The rendered ad is also tracked to identify whether a conversion takes place.

If the appropriately formatted 3D ad is not in the database (block 355—No), at block 360, the server converts the 2D ad to an appropriately formatted 3D ad, where the format is determined by the type of target electronic device that will display the rendered ad.

Next, at decision block 365, the server determines whether the conversion from 2D to the appropriate 3D format was successful. If the conversion was successful (block 365—Yes), at block 367, the server renders the 3D ad and tracks whether a conversion takes place.

If the conversion was not successful (block 365—No), the process returns to block 317, and the server renders the 2D version of the ad.

Returning to the path following decision block 348 for a server that is configured to perform offline conversions, at block 390, the server retrieves the appropriate pre-converted 3D ad from the repository and renders the ad. The server also tracks whether a conversion takes place based on the rendered 3D ad.

Returning to decision block 346, if there are not restrictions on the number of 2D/3D ads rendered (block 346—No), the process continues to decision block 348.

Returning to the path following block 322 for which the server places the ad based on a direct or shared buy, at block 380, the server evaluates characteristics of the available inventory and compares it to the specified targeting options provided by the advertiser. Then at decision block 382, the server determines whether the targeting options selected by the advertiser at block 305 are met by the inventory. The targeting options evaluated at decision block 382 do not determine whether a 2D or 3D ad should be rendered. The targeting options only consider whether the inventory meets the advertiser's requirements for whether the ad should be placed. If the targeting options are not satisfied (block 382—No), the process returns to block 380 to evaluate another available inventory.

If the targeting options are satisfied (block 383—Yes), at decision block 383, the server determines whether there are any restrictions on the number of 2D and 3D ads that are to be rendered. If there are restrictions (block 383—Yes), at block 384, the server evaluates targeting selections provided by the advertiser to determine whether to render the 2D version or the 3D version of the ad.

At decision block 385, the server determines whether the 2D version of the ad should be rendered. At decision block 385, if the server determines that the 2D version of the ad should be rendered (block 385—Yes), the process returns to block 317 for traditional serving and rendering of the 2D version of the ad.

If the server determines that the 3D version of the ad should be rendered (block 385—No), at block 386, the server retrieves the appropriate pre-converted 3D ad from the repository and renders the ad. The server also tracks whether a conversion takes place based on the rendered 3D ad.

FIG. 4 is a block diagram showing an example of the architecture for a computer system 400 that can be utilized to implement the techniques described herein. The system 400 can reside in the host server. In FIG. 4, the system 400 includes one or more processors 410 and memory 420 connected via an interconnect 430. The interconnect 430 is an abstraction that represents any one or more separate physical buses, point to point connections, or both connected by appropriate bridges, adapters, or controllers.

The processor(s) 410 can include central processing units (CPUs) that can execute software or firmware stored in memory 420. The processor(s) 410 may be, or may include, one or more programmable general-purpose or special-purpose microprocessors, digital signal processors (DSPs), programmable, application specific integrated circuits (ASICs), programmable logic devices (PLDs), or the like, or a combination of such devices.

The memory 420 represents any form of memory, such as random access memory (RAM), read-only memory (ROM), flash memory, or a combination of such devices. In use, the memory 420 can contain, among other things, a set of machine instructions which, when executed by processor 410, causes the processor 410 to perform operations to implement the embodiments.

Also connected to the processor(s) 410 through the interconnect 430 is a network interface device 440. The network interface device 440 provides the system 400 with the ability to communicate with remote devices.

The system 400 can also include one or more optional input devices 452 and/or optional display devices 450. Input devices 452 can include a keyboard, a mouse or other pointing device. The display device 450 can include a cathode ray tube (CRT), liquid crystal display (LCD), or some other applicable known or convenient display device.

Methods and systems for rendering an autostereoscopic three-dimensional image or video as an online advertisement have been described. It will be appreciated by those of ordinary skill in the art that the concepts and techniques described herein can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method comprising:
receiving from an advertiser campaign information for determining a first two-dimensional (2D) advertisement to be served and displayed online and a second a three-dimensional (3D) advertisement to be served and displayed online pursuant to a real time bidding auction, wherein the 3D advertisement is a version of the 2D advertisement, wherein the information is received via a communications interface at a host server;
receiving a selection of targeting options for the 2D advertisements and 3D advertisements at the host server;
via a processor at the host server, identifying an online impression on a first electronic device that satisfies the selection of targeting options;
via the processor at the host server, determining from the campaign information and the selection of targeting options whether the 2D advertisement or the 3D advertisement is to be rendered for the online impression; and
via the processor at the host server, rendering the determined advertisement online in real time during a real time bidding auction bid process in a resolution that is suitable for display by the first electronic device, wherein the determined advertisement has a format suitable for display on the first electronic device.

2. The method of claim 1, further comprising:
receiving the 2D advertisement from the advertiser; and
converting the 2D advertisement to the 3D advertisement via the processor at the host server, wherein the 3D version is autostereoscopic, and further wherein the 3D advertisement has a format suitable for rendering on the first electronic device.

3. The method of claim 2, further comprising:
tagging the 3D advertisement with formatting information;
storing the tagged 3D advertisement in a database.

4. The method of claim 3, retrieving the tagged 3D advertisement for rendering for display by a second electronic device having a same type as the first electronic device.

5. The method of claim 1, further comprising:
providing a preview of the 3D advertisement to the advertiser for approval.

6. The method of claim 1, further comprising:
tracking a response of a user of the first electronic device to the 3D advertisement, wherein the 3D advertisement is the determined advertisement.

7. The method of claim 1, wherein the targeting options include at least one of behavioral targeting options, contextual targeting options, retargeting options, geo targeting options, technographic targeting options, gender targeting options, deal targeting options, and site list targeting options.

8. The method of claim 1, further comprising:
receiving from the advertiser the 2D advertisement and the 3D advertisement, wherein the 3D advertisement is autostereoscopic.

9. The method of claim 1, wherein the two-dimensional advertisement is an image or a video.

10-13. (canceled)

14. An electronic device comprising a processor and a memory storing instructions which, when executed by the processor, cause the electronic device to perform operations comprising:
receiving a two-dimensional advertisement from an advertiser, via a communications interface;
receiving from the advertiser a selection of targeting options, via the communications interface;
receiving from the advertiser information for determining a first number of the two-dimensional advertisement to be served and displayed online and a second number of a three-dimensional advertisement to be served and displayed online pursuant to a real time bidding auction, wherein the three-dimensional advertisement is a version of the two-dimensional advertisement, and wherein the three-dimensional advertisement has one of a plurality of formats;
receiving a first request for bidding for a first online impression for a first electronic device;
upon determining that the selection of targeting options are satisfied by the first online impression, submitting a first bid;
based upon the advertiser information, determining via the processor whether to render the two-dimensional advertisement or the three-dimensional advertisement;
upon winning the first bid and determining to render the three-dimensional advertisement, converting the two-dimensional advertisement to the three-dimensional advertisement, wherein the three-dimensional advertisement has a suitable format for displaying on the first electronic device; and
rendering the three-dimensional advertisement online in real time during a real time bidding auction bid process for display on the first electronic device, wherein the three-dimensional advertisement is autostereoscopic.

15. The electronic device of claim 14, wherein the process further includes:
tracking a response of a user of the first electronic device to the rendering of the three-dimensional advertisement.

16. The electronic device of claim 14, wherein the process further includes:
tagging the three-dimensional advertisement with formatting information; and
storing the tagged three-dimensional advertisement in a database.

17. (canceled)

18. The electronic device of claim 14, wherein the targeting options include at least one of behavioral targeting options, contextual targeting options, retargeting options, geo targeting options, technographic targeting options, gender targeting options, deal targeting options, and site list targeting options.

19. The electronic device of claim 14, wherein the two-dimensional advertisement is an image or a video.
